(19) United States
(12) Patent Application Publication
(10) Pub. No.: US 2006/0087929 A1
(43) Pub. Date: Apr. 27, 2006

(54) Optical disk drive using one dimensional scanning

(75) Inventors: Tsuriel Assis, Rehovot (IL); Rann Glaser, Givatayim (IL); Isaia Glaser-Inbari, Givatayim (IL)

Correspondence Address: BROWDY AND NEIMARK, P.L.L.C.;624 NINTH STREET, NW, SUITE 300, WASHINGTON, DC, 20001-5303, US

(73) Assignee: MMRI Photonics Ltd., Tel Aviv (IL)

(21) Appl. No.: 10/519,924

(22) PCT Filed: Jun. 1, 2003
(86) PCT No.: PCT/US03/20610

§ 371 Date: Sep. 7, 2005

Related U.S. Application Data
(60) Provisional application No. 60/392,604, filed on Jul. 1, 2002.

(51) Int. Cl. G11B 7/00

(52) U.S. Cl. 369/44.14; 369/44.11

(57) ABSTRACT

A system for optical scanning along one line with fast random access and high optical resolution, composed of: a plurality of first lenslets (240) constructed for use with a selected media format (224), the plurality of lenslets (240) all being disposed in a single row and being spaced apart by a given center-to-center distance; a movable mount carrying the plurality of lenslets (240), a linear motion actuator (241) coupled to the mount for moving the mount in a direction substantially parallel to the single row over a distance having a maximum value that is substantially equal to or slightly greater than the given center-to-center distance; at least one light source (260); a light directing unit (234) for directing light from the source to any one or two selected lenslets (240); and a control unit for controlling the light directing unit (234).

### CROSS-REFERENCE TO RELATED APPLICATION

This application relates to subject matter disclosed in U.S. application Ser. No. 09/984,369, filed Oct. 30, 2001, the entire disclosure of which is incorporated herein by reference.

### BACKGROUND OF THE INVENTION

Optical disk drives that utilize a combination of a scanner (or scanners or beam steering device or devices) and a lenslet-array were described in Refs. [1], [2] and [3]. The disclosures, including the terminology, generalizations, and conventions used in Refs. [1] and [2], as well as works cited therein, are incorporated herein by reference.

In most of the embodiments described in references [1] through [3], there is a stationary two dimensional (2-D) lenslet array, and some means for two dimensional beam steering (or scanning), in order to facilitate addressing each lenslet in the two dimensional array individually (see, for example, FIG. 1, which is taken from ref. [1]). The relatively large two-dimensional array is more cumbersome and costly than a one dimensional (1-D) lenslet array, and the two-dimensional beam steering mechanism is clearly more complex, and therefore inevitably more expensive, than a scanner, or beam steerer, that scans in one dimension only. Furthermore, a system using a two dimensional lenslet array and scanning is likely to occupy a larger volume, which is undesirable in certain applications such as portable ‘notebook’ computers. The present invention provides ways to reduce manufacturing and part costs for lenslet array-based optical disk drives, specifically by using a 1-D lenslet array.

Reference [2] describes an optical disk drive with a single, moving, lens (rather than a stationary lenslet array) and 1-D scanning apparatus (FIG. 18 and its description in Ref. [2]). That configuration can be less expensive and more compact than the 2-D lenslet array based configurations of Refs. [1] and [2], but the seek time it can offer is not quite as short. For example, the stationary lenslet array configurations of Refs. [1] and [2] can achieve worst-case seek time of 3 msec or perhaps less. To obtain the same seek time with the configuration of FIG. 18 of Ref. [2] for a standard DVD or CD class disk, the acceleration of the moving lens aₗₑₙₛ , needed is given by

$${a}_{lens} \geq \frac{4 s}{{t}^{2}} \qquad ( 1 )$$

where s is the distance over which the lens moves and t is the desired seek time. The case where the first half of the movement time is used for constant acceleration and the second half for constant-deceleration gives aₗₑₙₛₗₑₜ=4 s/t². Using t=3 msec and s=35 mm, we get aₗₑₙₛ≈1,500 g (g being the acceleration due to gravity). Such acceleration is clearly impractical in a compact, relatively inexpensive, reusable, device.

Since the present invention relates to improvements in the devices disclosed in Refs. [1] and [2], the following discussion frequently refers to these references and the figures thereof.

### BRIEF SUMMARY OF THE INVENTION

Instead of moving a single lens across the entire usable part of the radius of the disk media, the entire usable part having the dimensions, the present invention provides a single line of N lenslets for a given media format that need be moved by a much smaller amount s/N, and that access data through the particular lenslet that happens to cover the desired location on the disk.

### BRIEF DESCRIPTION OF THE DRAWING

FIG. 1 is a perspective view of a previously proposed disk drive.

FIGS. 2-4 are perspective views of embodiments of the invention.

FIG. 5 is a side elevational view of an embodiment the invention.

FIGS. 6A and 6B are plan views of embodiments of the invention.

FIG. 7 is a perspective view of an embodiment of the invention.

FIG. 8A is a plan view of an embodiment of the invention.

FIG. 8B is an detail plan view of an element of the embodiment of FIG. 8A.

FIGS. 9, 10A and 10B are views similar to those of FIGS. 7, 8A and 8B, respectively, of another embodiment of the invention.

FIGS. 11A and 11B are perspective views of two forms of construction of an element of embodiments of the invention.

FIGS. 12 and 13A-13D are diagrams illustrating the operation of embodiments of the invention.

FIGS. 14A and 14B are a perspective view and a side view, respectively, of another embodiment of the invention.

FIGS. 15A, B and C are elevational views of three states of selected elements of the embodiment of FIG. 14 for implementing a first approach to correcting for changes in the vertical position of the data disk surface.

FIGS. 16A, B and C are elevational views of three states of selected elements of the embodiment of FIG. 14 for implementing a second approach to correcting for changes in the vertical position of the data disk surface.

FIG. 17 is a perspective view of a further embodiment of the invention.

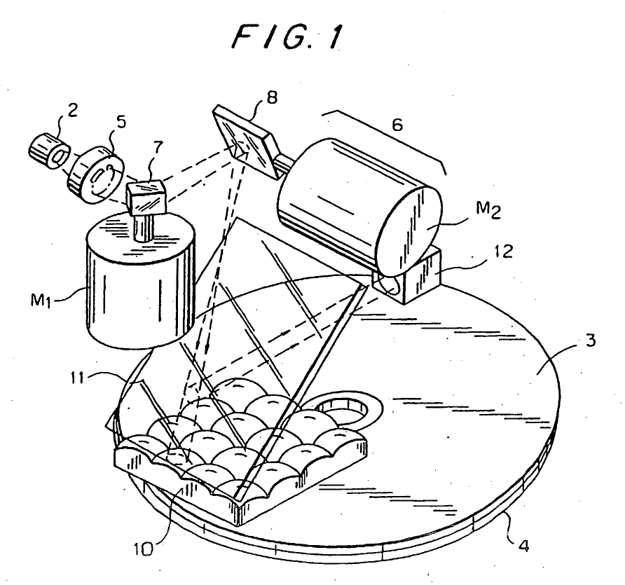

### DETAILED DESCRIPTION OF THE INVENTION

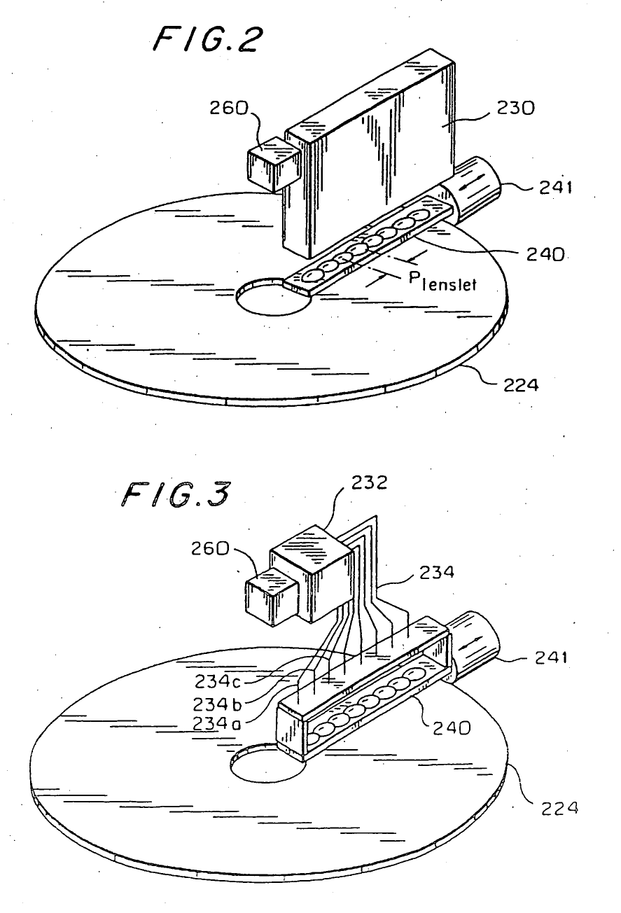

A basic simplified form of a disk drive according to the present invention is depicted in FIG. 2. A linear array 240 of lenslets is positioned above optical media 224. For reasons to be explained below, it may be desirable to provide more than a single linear lenslet array in some cases. Array 240 can be moved by an actuator 241 by a distance equal to, or slightly greater than, Pₗₑₙₛₗₑₜ≈s/N (see FIG. 2). Here, N is the number of the lenslets in the linear array and s is the usable portion of the disk radius, where:

$$s = \frac{{D}_{outer} - {D}_{inner}}{2}$$

where Dₒᵤₜₑᵣ is the diameter of the outmost data track on the disk, and Dᵢₙₙₑᵣ is the diameter of the innermost data track on the disk.

To access the proper location on disk 224, light from a source, typically a laser, in a subsystem 260 is directed by a beam steering, or light deflector, device 230 toward the selected lenslet of array 240. Device, or sub-system, 230 can be any suitable device that can direct a light beam in one of many possible directions, including, but not limited to, devices using moving mirrors, moving prisms and/or moving lenses, as well as electro-optical and/or acousto-optical beam deflectors and/or any of the devices described in Refs. [4-9]. For readout, light reflected from the data surface re-enters the same lenslet which sends the light through the same device 230 towards assembly 260, which, in addition to having a light source, also contain a detector or detectors, and possibly other optical elements as needed in optical disk drive heads, including any or all of beam shaping lenses or prisms, beam splitter, elements that modify the polarization state of light, etc.

One specific embodiment is schematically depicted in FIG. 3 and utilizes a bundle 234 of fiber optics to transfer light from laser/detectors assembly 260 to lenslet array 240. Fiber optics bundle 234 is composed of at least N (N=number of lenslets in the array 240) individual fibers 234ₐ, 234_{b}, 234_{c}, etc., possibly bundled, over at least part of their length, into a ribbon shape. These fibers and/or bundle are flexible over at least part of their length. One end of each fiber is positioned above a respective lenslet of array 240 and may be connected to move with the lenslet array. Alternatively, the fiber ends may be mounted to allow them to undergo a small degree of motion relative to the lenslet array, controlled by an additional actuator, possibly using piezoelectric element(s) that will move the spot of the focused light across the data surface of disk 224. This can be used for small rapid tracking error correction.

Fibers 234 are typically of the single transverse mode type. The location of their lenslet-side tips is such that the light exiting from each fiber essentially fills the aperture of the respective lenslet, and the lenslet focuses this light on the data surface of the disk. The other ends of the fibers enter a device 232, which serves as an optical exchange: light from the laser in unit 260 is directed to the individual fiber that communicate with the desired lenslet, and light that returns from that lenslet is coupled out towards the detector or detectors in unit 260.

Exchange device 232 may be based on any of the approaches described above for unit 230 of FIG. 2, may be an integrated optical device, or planar (substrate-mode) optical device using guided light and electro-optical or acousto-optical switches or scanners, or some other light exchange similar in principle of operation to those proposed and/or used with some fiber-optics communication systems.

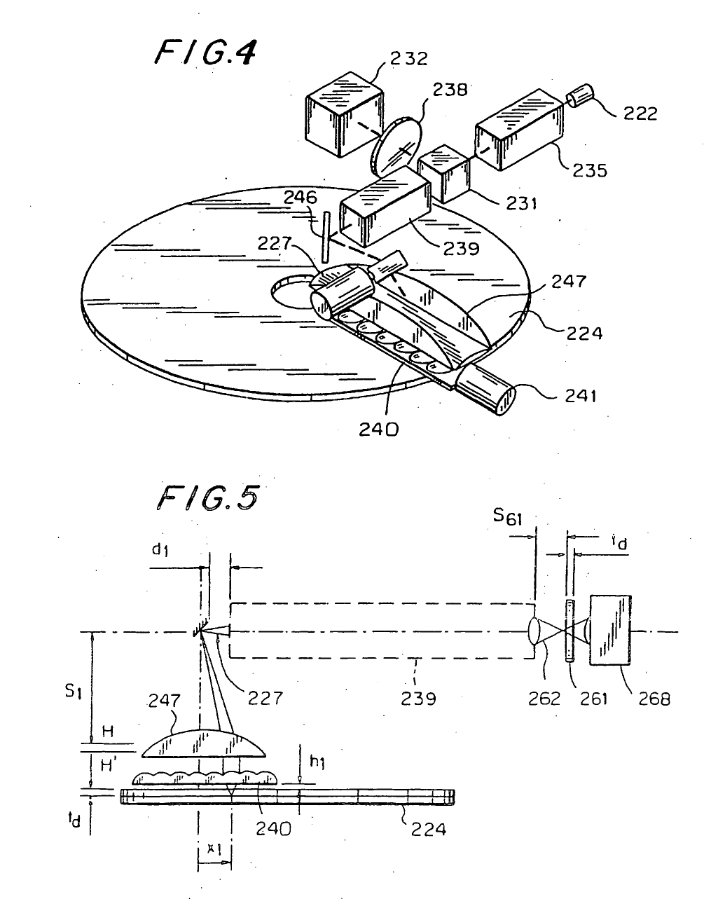

FIG. 4 is a schematic view of yet another embodiment of the present invention. Like the device shown in FIG. 18 of Ref. [2], the device of FIG. 4 has a laser light source 222, a beam shaping optical sub-unit 235, a beam splitter 231, a relay optics sub-unit 239, a stationary optional mirror 246, a single axis mirror-actuator scanner 227, a large lens 247, which may be cut as shown to save space and manufacturing costs, and the data carrying optical disk 224. There are also an optional collecting lens 238 and detector assembly 232. However, the single moving lens, corresponding to lens 40 in FIG. 18 of Ref. [2], is omitted. Instead there is provided a linear, 1-D, array of lenses, or lenslets, 240. Array 240 is coupled to an actuator 241, which can affect motion along the length of lenslet array 240.

FIG. 5 is a simplified cross-sectional view of an embodiment that differs somewhat from that of FIG. 4. In FIG. 5 there is an optical disk drive head 268 that is similar, and that may be actually identical or nearly identical in construction, to a conventional optical disk drive head. The only major difference is that, unlike conventional drives, sub-unit 268 here is stationary. Sub-assembly 239 is modified, relative to subunit 239 of FIG. 4, so that it accepts light from a diverging beam. This can be done, for example, by adding a lens 262. A transparent plate 261 may be needed to correct some optical aberrations.

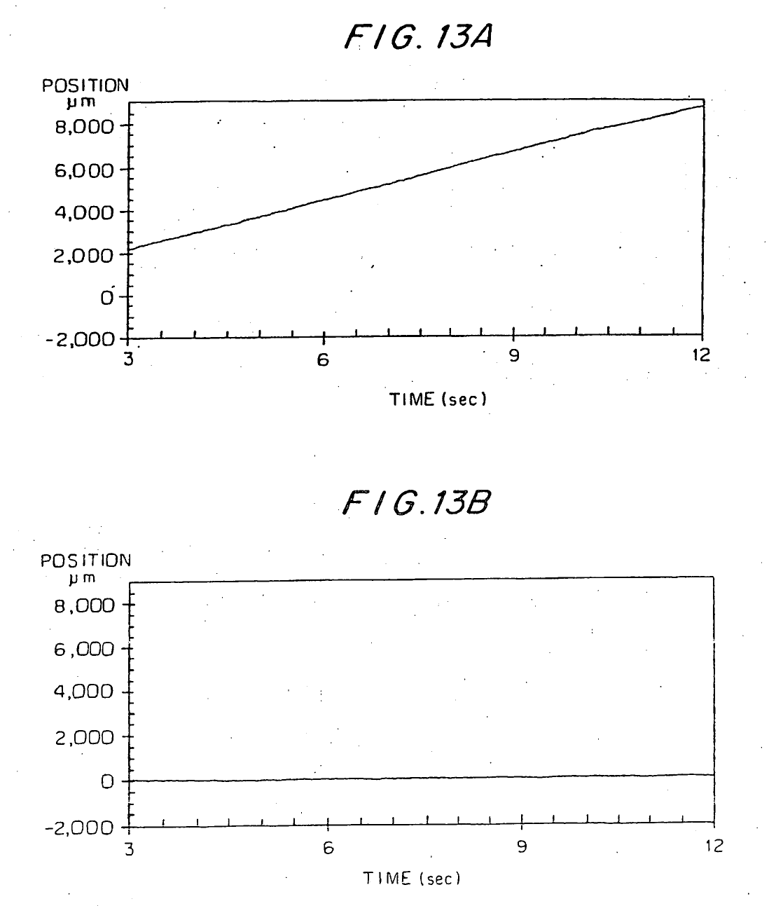

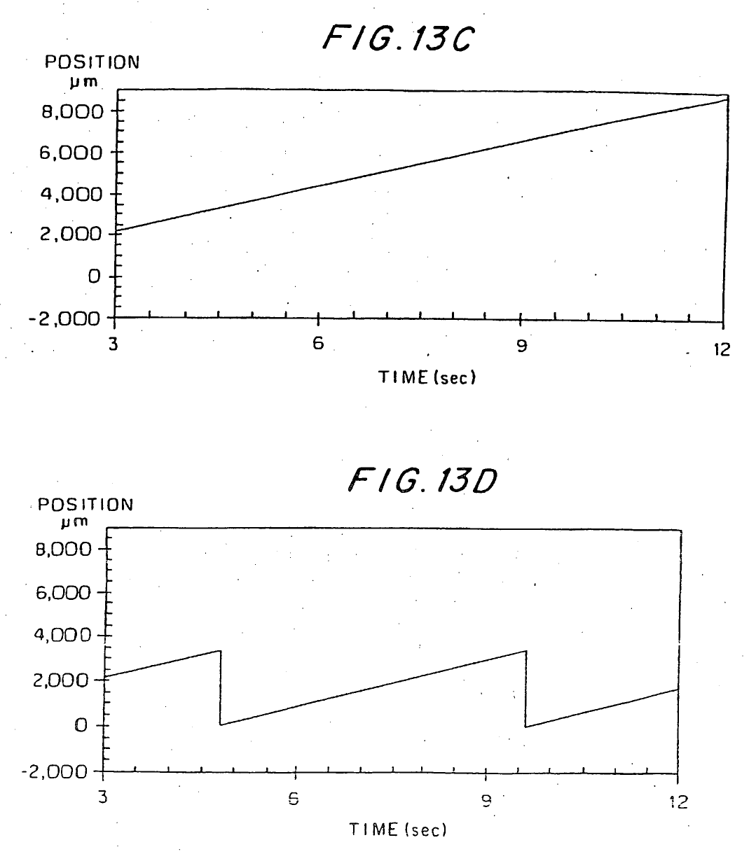

The rest of the optical configuration may be similar to that of FIG. 4. In FIG. 5, the optional mirror 246 of FIG. 4 is omitted, but it may optionally be used here as well. Actuator 241 is used also with the configuration of FIG. 5, even though it was omitted from the drawing for clarity. The drive shown in FIG. 5 is similar to that shown in FIG. 13 of Ref. [2]. Here, however, lenslet array 240 is one dimensional, whereas in FIG. 13 of Ref. [2] lenslet array 30 is two-dimensional. Additionally, the configuration of FIG. 13 of Ref. [2] has a two-axes scanner or two single-axis scanners (reference numerals 26 and 27 in Ref. [2]) while in FIG. 5 here there is a single, one axis, scanner 227.

In operation, both in FIG. 4 and in FIG. 5, scanner 227 sends the laser beam towards a single selected lenslet in array 240. The lenslet array can move, using actuator 241, by an amount equal to, or somewhat greater than, the pitch of the lenslets in array 240, the pitch being the distance between the centers of two adjacent lenslets in that array. Thus, for any track on the optical disk, there is at least one lenslet that can be positioned right above it such that, when the laser light is focused by it, the focused light will illuminate a spot on that specific track. As with embodiments of Refs. [1] and [2], reflected light from the data layer in the disk traces back the same path as incoming light, where it is redirected by a beam splitter (231 in FIG. 4, an internal beam splitter in sub-unit 268 of FIG. 5) towards a suitable detector array or detector assembly.

Yet another variant on the basic system of FIG. 2 is to use multiple lasers, rather than one or a few lasers, such that each lenslet in array 240 has its own laser. These lasers may, be mounted on the same moving platform as the lenslets, or may be mounted in a separate unit, possibly in the form of a single-chip semiconductor laser array, with each laser connected to an associated lenslet by an optical fiber or other suitable means.

To demonstrate the advantage of the short-movement single row lenslet array concept, if one assumes, for example, that the pitch of the lenslets in array 240 in FIGS. 2 through 5 is pₗₑₙₛₗₑₜ=3.5 mm, and aim for a worst case seek time of 3 msec, ea. (1) shows that the acceleration needed is only aₗₑₙₛ ≈150 g. The mass of the lenslet array, assuming that it is molded from plastic, with a specific gravity of

$$ρ \approx {1}_{\frac{Kg}{{m}^{3}}} ,$$

roughly equals 0.6 gram. If another 0.5 gram is allocated for some mechanical fixture, the overall mass becomes 1.1 gram, and the force needed to accelerate it roughly equals 165 Kg. Such accelerations and forces are comparable to those used, for example, in some common loudspeaker coils and can be achieved using common, inexpensive, components.

In the embodiment shown in FIGS. 4 and 5, part 239 is similar, but not necessarily identical, to part 39 disclosed in Ref. [2]. Furthermore, for example, part 7 in Ref. [1] part 27 in Ref. [2] and part 227 here are all similar in function and can be implemented by similar means. Parts that are substantially modified receive new numbering here—the lenslet array was part 10 in ref [1], and part 30 in Ref. [2]. As the array shrank from 2-D to 1-D, it was renumbered as 240 (rather than “230”). The large lens here was 37 in most of the Ref. [2], except in FIG. 18 thereof where it was cut down and numbered 47. Here it is 247, because it may also be cut out similarly.

It is noted here that, though throughout most of this document, array 240 is described as “linear”, lenslets on the array may be arranged on a slightly curved line rather then a straight one. This may be needed, for example, in some optical configurations where lens 247 translates the angular motion of the light beam affected by scanner 227 into a curve rather than a straight line at the lenslet plane.

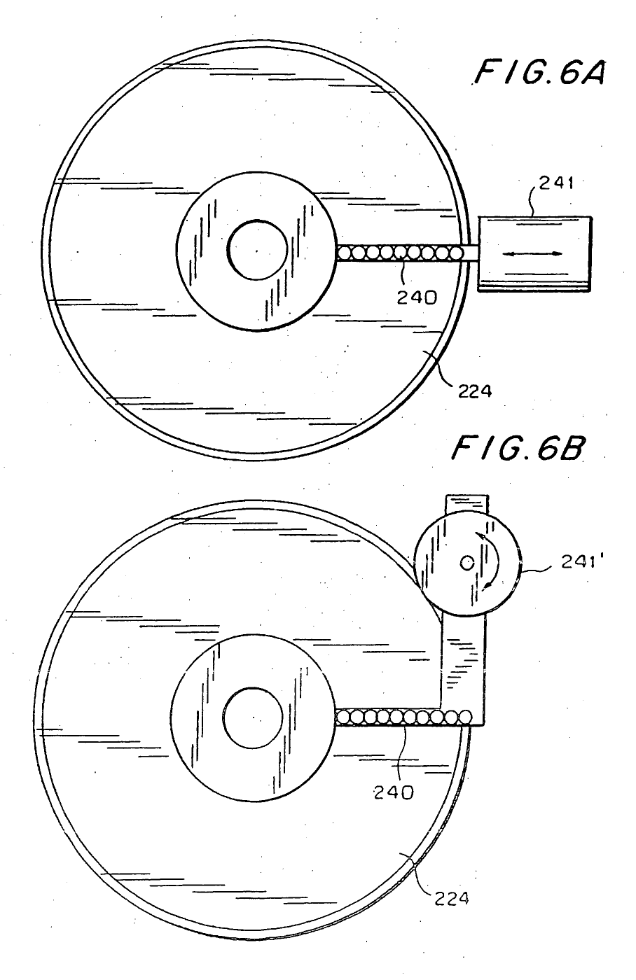

FIGS. 6A and 6B depict two alternative examples of arrangements for moving the linear lenslet array. Both figures present a top view of the disk 224, the lenslet array and the actuator, with all other components not shown for clarity.

In FIG. 6A, a linear actuator 240, such as, for example, a voice coil actuator or a piezoelectric device, or, possibly, a rotational motor or actuator with some suitable mechanical rotation-to-linear motion conversion, is coupled to the linear lenslet array 240 directly. The configuration of FIG. 6A is the same as that of FIG. 4.

FIG. 6B shows a rotational actuator 241′, such as a galvanometer or other type of electric motor, for example, and an arm (shown as part of the lenslet array 240) to effect a similar motion.

The configuration of FIG. 6A may require a linear bearing, or possibly a flexure mount (not shown in the figures), to ensure that the lenslet array moves only along the required dimension. In FIG. 6B, the bushing of the rotational actuator 241′ can provide this function, possibly with lower friction. It is noted, however that the moving mass in the configuration of FIG. 6B is likely to be larger than that of FIG. 6A. Furthermore, because the motion effected by the actuator of FIG. 6B is circular rather than linear, there is also a small sideways movement of the lenslets. To keep this movement sufficiently small, it is necessary to have the arm (shown as part of lenslet array 240 in FIG. 6B) relatively long, resulting in a still larger moving mass and moment of inertia. The examples of FIGS. 6A and 6B are by no means exhaustive: many other ways of holding and moving the lenslet array are available, and may be used with this invention.

Referring back to FIG. 5, sub-unit 239 has the same function as, and, possibly, may be identical to, sub-unit 39 of FIGS. 6,7,8,9,11,12, and 13 of Ref. [2]. FIG. 8 of Ref. [2], together with the related description therein, specifies the optical behavior of sub-unit 39 together with large lens 37, which is the same as that of sub-unit 239 together with lens 247 in FIGS. 4 and 5 herein.

Together, sub-unit 239 and lens 247 image light from the entrance pupil of sub-unit 239, which pupil is in an entrance pupil plane in FIG. 5 herein and is designated as plane P in FIG. 8 of Ref. [2], onto the common entrance pupil Plane of all lenslets in the lenslet array (plane P₃₀ in FIG. 8 of Ref. [2]. Thus, as shown in FIG. 8A of Ref. [2], a plane wave at the entrance pupil plane will exit lens 247 (37 in FIG. 8 of Ref. [2]) as a plane wave at the common entrance pupil plane of the lenslet array. Likewise, a point source of light at plane P_{P} in FIG. 8B of Ref. [2] will image to a point at plane P₃₀ in FIG. 8B of Ref. [2].

As the light beam is moved with the aid of scanner 227 of FIG. 4 or 5, light will be directed to a different lenslet in array 240. However, since the distance S₁ between the optical center (the first principal plane, denoted as H in FIG. 5) of lens 247, and the rotation axis of scanner 227 is equal to, or nearly equal to, the focal length of lens 247, the direction of the light beam that exits lens 247 is essentially independent of the angular position of scanner 227.

If the angle of incidence of light to sub-unit 239 changes, also the angle that light exits lens 247 changes. For small angles, the change in the two angles depends on the ratio between the focal lengths of sub-unit 239 and lens 247:

$$\frac{Δ {α}_{247}}{Δ {α}_{239}} = \frac{{F}_{239}}{{F}_{247}} \qquad ( 2 )$$

where Δα₂₃₉ and Δα₂₄₇ are changes in the angles between the center of the beam (main ray) and the optical axes of sub-unit 239 and lens 247 respectively, and F₂₃₉ and F₂₄₇ are their focal lengths. Typically, but not necessarily, F₂₃₉≈F₂₄₇.

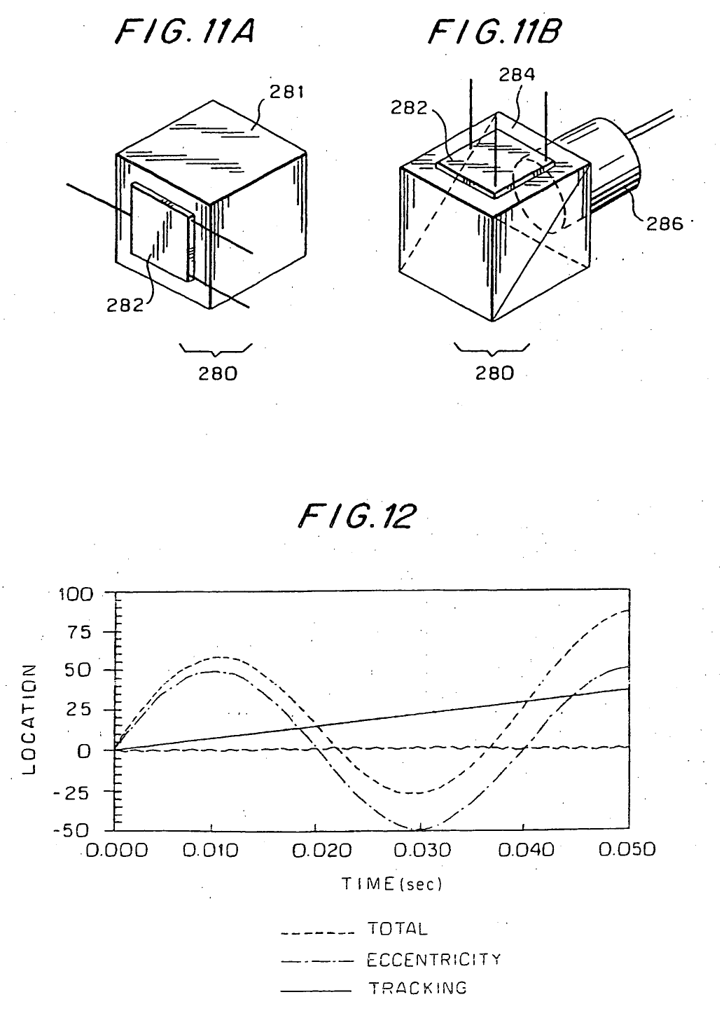

Two alternative ways of changing the angle of incidence of light to sub-unit 239 of FIG. 5 are shown in FIGS. 11 and 12 of Ref. [2] and FIG. 5 herein, respectively. In FIGS. 11 and 12 of Ref. [2], another scanning element, 70, is added. It directly controls that angle of incidence. In FIG. 5 herein, there is an optical head sub-unit, 268, that contains a focusing lens. As noted earlier, sub-unit 268 is similar in function, and possibly in construction, to the optical disk drive head found in conventional optical disk drives, except that here it is stationary. The focusing lens of subunit 268, however, is typically mounted on a two-axis translation actuator that can move it both axially (towards or away from sub-unit 239) and in a transverse direction. As the focusing lens of sub-unit 268 moves sideways, so does the spot of the light (center of convergence) created by it. When this light enters lens 262 and sub-unit 239, transverse motion of the focused spot of light becomes a change in the direction of the light that goes from lens 262 into sub-unit 239. It is noted that both the methods of FIGS. 11 and 12 of Ref. [2] and of FIG. 5 herein, can be employed with this invention.

Thus, the position of the spot where light is focused onto the data surface of disk 224 is determined here by three factors:

1. The specific lenslet selected.

2. The position of the lenslet array, as affected by actuator 241 (FIGS. 4 and 6).

3. The angle of incidence of light to the lenslet, as discussed above.

Specifically, the location of that spot, xₛₚₒₜ, for lenslet number nₗₑₙₛₗₑₜ is thus given by:
xₛₚₒₜ=x₀₀+nₗₑₙₛₗₑₜpₗₑₙₛₗₑₜ+x₂₄₁+S′ₗₑₙₛₗₑₜ tan α₂₄₇ (3)

where x₂₄₁ is the amount of movement of the lenslet array effected by actuator 241, x₀₀ is the location of the center of the first lenslet (nₗₑₙₛₗₑₜ=0) in the array for x₂₄₁=0, lenslets are numbered as nₗₑₙₛₑₜ=0. . . N-1, where N is the total number of the lenslets in the row, nₗₑₙₛₗₑₜ is the specific lenslet selected by scanner 227, pₗₑₙₛₗₑₜ is the pitch (center to center distance) of the lenslets, S′ₗₑₙₛₗₑₜ is the effective distance between the lenslet and the disk data surface (corrected for the refractive index of the disk material) and α₂₄₇ is the angle between the center of the beam as it exits lens 247 and the optical axis of lens 247, which is parallel to the optical axes of all lenslets in array 240). The term “tan α₂₄₇” assumes distortion free imaging by the lenslets; in practice there would be some minor distortion, so “tan α₂₄₇” is an approximation of a somewhat more complex function α₂₄₇ that depends on the details of the optical design of the lenslets in array 240.

Typically, for the largest allowed value of α₂₄₇, α_{247,max}, S′ₗₑₙₛₗₑₜ tan α_{247,max} is significantly smaller than pₗₑₙₛₗₑₜ/2. In other words, there are locations on the disk that cannot be accessed by a single, stationary, row of lenslets. Refs. [1] and [2] solved this problem by adding additional rows of lenslets, creating a two-dimensional lenslet array, and adding 2-D scanning. Here we solve the same problem by allowing a small movement (equal to, or very slightly larger than, pₗₑₙₛₗₑₜ).

The spot of light on the disk must be moved in order to—

a) Compensate for eccentricity and tracking error: disks are not perfect. For example, the DVD standard allows eccentricity error of up to 0.1 mm (peak to peak), which approximately equals the total width of about 135 tracks. We must correct for this error even if we need to read only a single track.

b) Perform track following—for larger data sets, we need to access several adjacent tracks. The amount of change needed per disk revolution is very slight, so this requires relatively slow movement of the spot.

c) Starting a new random access read or write operation—here we may need to go as fast as we can and the change in the spot position can be as much as jumping from the first track to the last one.

Typically, eccentricity following is done by changing the angle of incidence of light entering sub-unit 239, as discussed above. Track following is done most of the time with actuator 241, which moves the lenslet array. However, when exceeding the range covered by the motion of actuator 241, it is necessary to use another lenslet. This is accomplished by moving both scanner 227 and actuator 241. Finally, moving both scanner 227 and actuator 241 is used for most of the random access operations. As the lenslet array is moved by actuator 241, it is desirable to move scanner 227 at a rate such that the light will keep filling the aperture of the selected lenslet.

It is possible to further simplify the optical system by not having any means to change the beam angle α₂₄₇, and use actuator 241 also for eccentricity control. However, the frequency of mechanical movement needed to do that is high, considering that already some disk drives rotate at 10,000 RPM, and may increase the cost of a suitable unit 241.

Multi-Format Support

Often, an optical disk drive must support more than a single format or media type. For example, DVD drives are usually expected to support also CD media and formats. The optical requirements for DVD and CD media/formats differ—

Value

| Specification | Units | CD | DVD |
|---|---|---|---|
| Focusing Numerical Aperture | — | 0.4 to 0.5 | 0.6 to 0.65 |
| Cover layer thickness | mm | 1.20 | 0.60 |
| Laser Wavelength | nm | 780 | 650 |
| Track Pitch | μm | 1.60 | 0.74 |

Simple optical calculations show that a lens optimized to provide diffraction limited focusing for one of these formats would, in the absence of special design features, fail to do so for the other. Numerous methods have been described, and several methods are actually being used, to allow multi-format/media support by conventional optical disk drive. Some conventional heads actually have two separate focusing lenses, two lasers, and other duplicated components, with each lens/laser optimized separately for its respective format and media. Other methods employ some form of “overloading”, allowing one lens to function in both modes. For example, using a diffractive optical surface, it is possible to design a lens that is optimized for the parameters of CD when illuminated with 780 nm laser light, and for those of DVD at 650 nm (Refs. [10-11]).

Another method is to use electrically switchable optical elements, for example, using liquid crystal technology as shown in Ref. [12]. It is, of course, also possible to introduce a movable optical element (or elements) that, in one position, make the system optimal for one mode, and in the other position, for the other mode. For example, such compensating element (or elements) may be placed inside the optical path for one mode of operation and removed for the other.

It is specifically stated here that this invention includes also any, or at least most, means to facilitate such multi-mode operation, including those based on the principles described above, as modifications to the principles and embodiments described herein.

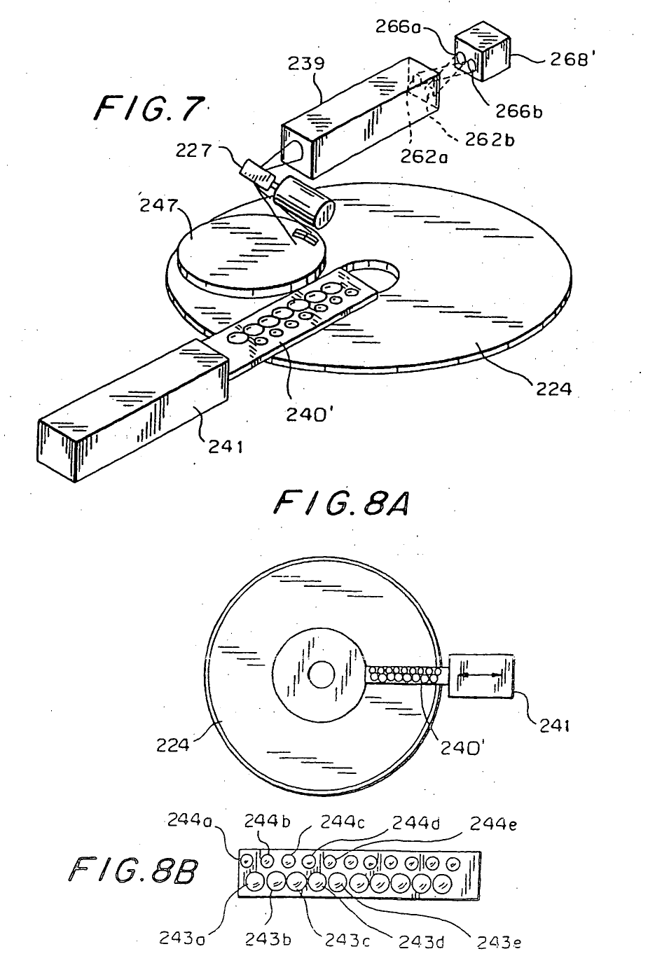

The following describes a method for supporting multiple formats/media in a disk drive that has a linear array and actuator, as shown and described earlier herein. FIG. 7 schematically shows such a drive, and FIGS. 8A and 8B are top plan views of some key subsystems.

FIGS. 7, 8A and 8B show a lenslet array 240′ that actually contains two rows of lenslets: in the enlarged view of FIG. 8B, lenslets 243ₐ, 243_{b}, 243_{c}, 243_{d}, 243ₑ, etc., are lenslets optimized for, in this example, DVD parameters; lenslets 244ₐ, 244_{b}, 244_{c}, 244_{d}, 244ₑ, etc., are lenslets optimized for, in this example, CD parameters. Both rows are mounted together. FIG. 7 shows that light coming from the laser/detectors assembly 268′ through lens 266ₐ will enter subsystem 239 through lens 262ₐ, and eventually reach one of the lenslets 244ₐ, 244_{b}, 244_{c}, 244_{d}, 244ₑ, etc. In contrast, light coming from laser/detectors assembly 268′ through lens 266_{b} will enter subsystem 239 through lens 262_{b}, and eventually reach one of the lenslets 243ₐ, 243_{b}, 243_{c}, 243_{d}, 243ₑ, etc.

Now, lens 266ₐ receives light, in this example, from a laser with wavelength of 780 nm, and that lens, as well as lens 262ₐ, are designed for 780 nm light. On the other hand, lens 266_{b} receives light from a laser with wavelength of 650 nm, and that lens, as well as lens 262_{b}, are designed for 650 nm light. Switching on either the 780 nm laser or the 650 nm laser selects the part of the optics that is actually used, and hence determines whether the system is optimized for CD or DVD.

The specific wavelengths (650 nm, 780 nm) and formats (DVD, CD) given above are presented as examples. Other wavelengths and formats are already in use and, quite certainly, more will follow. The adaptation of the description above to these other formats is obvious. Furthermore, would it be desirable in the future to support more than two basic formats (for example, using 780 nm, 650 nm, and 405 nm lasers with cover layers of 1.2 mm, 0.6 mm and 0.1 mm, respectively). The cover layer is the layer between the external disk surface and the data surface. The system schematically depicted in FIGS. 7, 8A and 8B can be readily extended to support these by simply adding a third row of lenslets in array 240′, and adding suitable lenses 266_{c} and 262_{c} at the appropriate location. The extension to even more wavelengths and formats is self-evident.

Method For Synchronizing The Linear Actuator With The Scanner

It was noted earlier herein that, or optimum system performance, scanner 227 and linear actuator 241 (FIGS. 4 through 8B) must move together in such way that the light beam that comes from lens 247 towards lenslet array 240 will always be centered, or nearly centered, with respect to the selected lenslet. It is noted that de-centering does not cause a significant error in the position of the spot created by the selected lenslet. The major problems in not having the beam and lenslet centered is light loss, since part of the beam misses the lenslet, and decrease in the effective numerical aperture of the lenslet, again since part of the aperture is not illuminated, which leads to increased spot size on the data plane of the optical disk media.

One way of synchronizing the linear actuator 241 and scanner 227 (FIGS. 4 through 8B) is the use of an open loop approach: for every accessible spot location on the disk one can calculate, either on-line, or by creating, in advance, a table in the controller memory, the required scanner and linear actuator positions, and control them by electronic commands, possibly using encoders or other position sensors on these actuators.

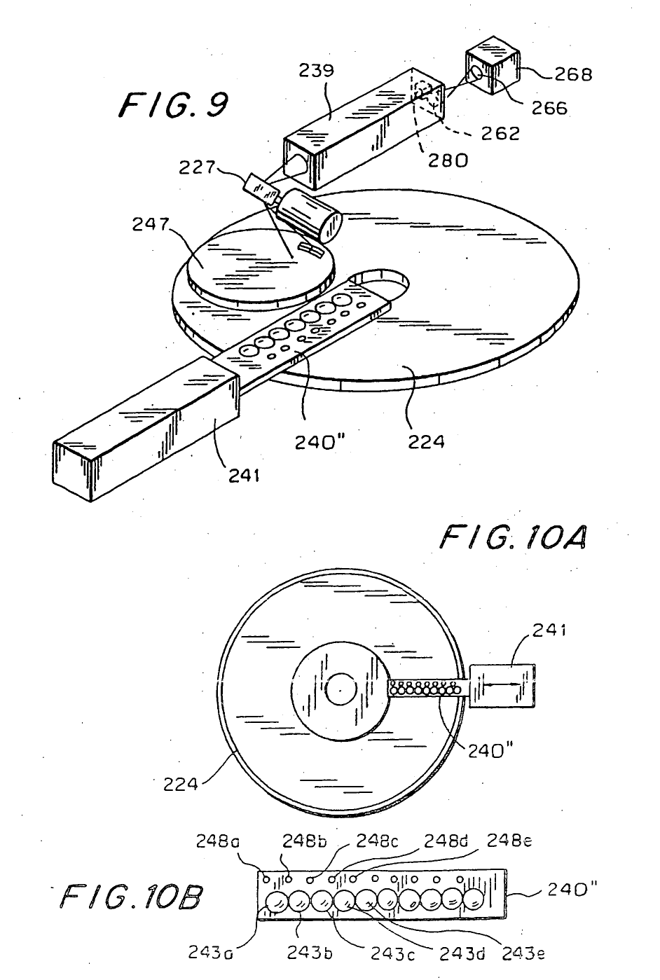

An alternative method is closed loop control, for which an example is schematically depicted in FIGS. 9, 10 and 11. FIG. 9 provides a general overview of the system. Lenslet array 240″ replaces lenslet array 240 of FIGS. 2 through 6. A top view of lenslet array 240″ is given in FIGS. 10A and 10B. The array has lenslets 243ₐ, 243_{b}, 243_{c}, 243_{d}, 243ₑ, etc., which are identical or nearly identical to the ones in array 240 in FIGS. 4 through 6, and to lenslets 243ₐ, 243_{b}, 243_{c}, 243_{d}, 243ₑ, etc. of FIGS. 7 and 8. These lenslets are used to focus laser light on the data surface of the optical disk media for readout and/or writing. Additionally, there are elements 248ₐ, 248_{b}, 248_{c}, 248_{d}, 248ₑ, etc.; these elements are either light sources, such as small LEDs, or retro-reflectors, such as silvered cube-corner indentions or small lenslets with mirrors at their focal planes, acting as cat's-eye retro-reflectors. A cube-corner is a structure having three orthogonal reflecting surfaces that reflect light back toward the light source. FIG. 9 also shows an additional component, 280, near entrance lens 262 for unit 239. Now, the combined optical system of sub-unit 239 and large lens 247 also images some of these emitters or reflectors 248ₓ at, or near, the location of device 280. This is because the system is designed to image the exit plane of lens 262 on the common entrance pupil of the lenslets in array 240″, and because the distance between the row of lenslets 243ₓ and the emitters/reflectors 248ₓ equals, or nearly equals, the distance between the centers of lens 262 and new device 280, times the combined magnification of the system of sub-unit 239 and large lens 247.

FIGS. 11A and 11B show two alternative configurations for device 280. FIG. 11A shows a variant of device 280, which is constructed from a split detector, or a one dimensional position sensing detector, 282, mounted or a holder 281. This configuration is used when elements 248ₓ of FIGS. 10 are light emitters. Light coming from one of these emitters is imaged, as described above, on the surface of detector 282. If it is centered, both outputs from this detector produce equal signals. If it is not, one of the two produces a stronger signal, indicating that the scanner 227 and the selected lenslet of array 240″, as positioned by actuator 241, are not properly aligned. This signal difference is used to drive an electronic feedback signal, which is used to correct the position of either scanner 227 or actuator 241.

The variation of FIG. 11B contains also a light source 286, possibly a LED or a laser, preferably emitting light at a wavelength somewhat different than that of a main read/write laser, and a beam splitter 284. Here, elements 248ₓ of FIG. 10 are retro-reflectors thet reflect part of the light coming from source 286 back towards device 280. The reflected light is directed at least in part by the beam splitter 284 to the split, or position sensing, detector 282, which is identical in function to detector 282 of FIG. 11A. The rest of the operation is identical to that of the FIG. 11A variant. Since the variant of FIG. 11B uses only passive retro-reflectors on the lenslet array 240″, this array, which contains both lenslets and retro-reflectors, can be molded together, with little or no assembly. Furthermore, unlike LEDs, the retro-reflectors require no electrical power, so there is no nead to place electrical wiring on array 240″, nor to connect it to an external electric power source. Since array 240″ has to move, the added ruggedness is yet another valuable advantage.

The effective position sensing direction in both FIGS. 11A and 11B is vertical. In FIG. 11B the sensing direction of the actual sensing element would be towards and away from light source 286, but the reflective surface in the cube converts this to up and down, in relation to the way they are shown in FIGS. 9, 11A and 11B. More generally, this direction should correspond to the direction of movement of the image of light sources/reflectors 248 (FIGS. 9 and 10), as formed through the optical system of devices 247, 227 and 239.

Control Algorithms and Circuitry

FIG. 12 is a diagram that shows the components of the required movement of the spot of light on the disk data surface, as generated by the optical disk drive system of the present invention along a radius of the disk. The precise values given in this diagram are typical of some DVD disk drives and media, but the general form applies to most optical disk Formats. Here the horizontal axis is Lime and the vertical axis is relative position along the radius. The track on the disk is usually a spiral, which must be followed during read and/or write operations. In the absence of other motion components, and assuming that the angular rotation velocity of the disk is constant, the spot would need to move at a constant velocity along the radius, as shown by the “tracking” line in the diagram. In practice, optical disks are unlikely to be centered. So, in order to follow the track, the spot must move also in a near sinusoidal pattern, as shown in the curve “eccentricity” in FIG. 12. Last, in rewritable optical disk media the tracks also contain small undulations, known as wobble. This is shown in the “wobble” line in the chart. As, in practice, the amplitude of the wobble is significantly smaller than the pitch of the tracks, the read/write laser spot does not usually need to follow it precisely. The “total” line of the chart shows the overall motion of the light spot along the radius.

Sequential Read or Write Operation

To effect this motion, the actuator of lens 256 of unit 268 (for example in FIG. 9), the scanner 227 and the lenslet array, using actuator 241 or 241′ (FIGS. 4 through 10), must all work together. For sustained long sequential read or write operation, using constant angular disk rotation velocity, this motion can be described by diagrams such as those of FIGS. 13A-13D, where it is assumed that the pitch of the lenslets in array 240 is 3.5 mm. The precise values given in these diagram are typical of some DVD disk drives and media, but the general form applies to most other formats and other lenslet pitch values. Note that the scale in time and position in FIG. 13 are much larger than in FIG. 12. Here, the “spot position” diagram of FIG. 13A shows where the spot must be at a given time; the “head actuator” diagram of FIG. 13B shows to the transverse position of the actuator of lens 266, i.e., the transverse position is the position to which array 240 would be moved to make small track following corrections. Array 240 could also be-moved parallel to the axis of disk rotation to move the spot created by the system up and down in order to effect focus correction. The “scanner” diagram of FIG. 13C portrays the position of the center of the beam coming through lens 247 at the pupil plane of lenslet array 240, as affected by the position of scanner 227; and the “mini sled” diagram of FIG. 13D shows the position of the lenslet array 240 as affected by actuator 241. In this text, the “mini-sled” is constituted by array 240, actuator 241 and associated mounting components. Here we see that the actuator of lens 266 is used for small, relatively fast motions, mainly to correct for eccentricity. The movements of both scanner 227 and the lenslet array actuator 241 are used to cover longer movements. As the combined motion approaches the end of the region covered through a single lenslet, actuator 241 must “fly-back” to its initial position by an amount equal to, or possibly slightly greater than, the pitch of lenslets in array 240 (Pₗₑₙₛₗₑₜ in FIG. 2); this result in the saw-tooth like shape of the “mini sled” curve in FIG. 13.

Random Access Operations

To effect fast random access operation, it is not sufficient to be able to move the laser light spot quickly along the optical axis. It is necessary also to “home” on the precise requested track in as little time as possible. Since conventional optical disk drives have long seek-time anyway, the added overhead of this final acquision is not significant for them. With very fast seek drives, such as those based on this invention or the inventions of Refs. [1] and [2], this extra time cannot be ignored. This section describes a method for expediting this final acquisition process with drives based on the invention as shown in FIGS. 2 through 11. Use shall be made of the terminology that is appropriate for the embodiments of FIGS. 4 through 11, with the understanding that the extension to those of FIGS. 2 and 3 is self-evident. Likewise, the same general method can be easily extended for use with drives based on the inventions of Refs. [1] and [2].

It is assumed here that the disk drive operates in a constant angular velocity (CAV) mode—the physical rotation speed of the disk media is the same for all track locations and the temporal data read/write rate varies with track location. CAV operation is already present on many optical disk drives and is an important factor in minimizing access time.

In the optical disk drives of the present invention there is some type of tracking sensor that measures the error in the location of the focused light spot at the data surface of the optical disk media—the distance between the center of this spot and the centerline of the track. Methods for implementing such sensors or detectors have been described in great detail in the technical literature (see, for example, ref. [13] and the references cited there). In a drive based on the present invention, the optical and electro-optical part of the sensor is located in the detectors assembly 232 of FIG. 4, or in the laser(s) and detectors assembly 268 of FIGS. 5, 7 and 9. It is connected to an electronic circuit (such as the one described, for example, in Ref. 13) that puts out a tracking error signal from which both the amount and the sign, or direction, of the error can be calculated. Using this signal, the actuators for lens 266 in assembly 268 (FIGS. 7 and 9), scanner 227 (FIGS. 4, 5, 7 and 9) and lenslet array mini-sled 241 (FIGS. 4, 6-10), data on current spot location (available by reading the sector headings on the disk), the known rotational velocity of the disk-media, and the address of the requested track, the following is done:

The system (electronics and software and/or firmware) calculates the actual physical position of the spot as a function of time, for example using integration on the tracking error signal and the read track number from the sector header.

Throughout the drive operation, using frequency domain filtering, the location signal is separated into

a) a track following signal (“tracking” in FIG. 12),

b) periodic movement due to eccentricity and possible mechanical imperfections (“eccentricity” in FIG. 12), which has the same frequency as the known disk media rotation, or frequencies that are small multiples (harmonics) of that frequency,

c) and, if present, the wobble signal (“wobble” in FIG. 12).

The amplitude of the wobble is sufficiently small to be ignored for tracking control. The wobble signal, if present, is therefore not used for actual track following and is directed to other parts of the control electronics.

Once the “jump” command is received, the normal feedback loop between the actuators and the tracking error signal is interrupted. Instead:

1. The tracking actuator of lens 266 starts moving so as to compensate only for the periodic movement due to eccentricity and possible mechanical imperfections.

2. The scanner actuator 227 and the mini-sled actuator 241 move directly to their new position, which is calculated by assuming that there is no eccentricity.

3. Once the scanner and mini-sled actuators reach their target position, normal feedback tracking is restored and the actual track number is read from the sector heading.

4. Using the actuator of lens 266, the spot is moved to the correct location. This final correction, together with locating the desired sector, takes, on the average the time of one-half of a disk revolution, known in the industry as latency.

5. Normal tracking is resumed.

As an example, assume that in a CAV DVD drive, the disk media rotates at approximately 2300 RPM, so each rotation takes approximately 26 msec. The latency is 13.msec. Typical initial track error using the above scheme would be 20 μm or less, the precision of the mini-sled actuator, which can be corrected in less than 5 msec, shorter than the latency time.

Since optical disks are mass produced, and they are usually far from being perfectly flat, and unlikely to be mounted precisely, the height of the area on the disk data surface just next to the focusing lens varies as the disk rotates. In conventional optical disk drives this change of height is compensated by an auto-focus mechanism containing focus error detection and means to move the focusing lens up and down so as to maintain an essentially constant distance between the lens and the local area at the disk data surface. In known optical disk drives using scanning and a lenslet array (for example Refs. [1] and [2]) a relatively large lenslet array was needed. For such cases, these prior art arrangments provided a possibility of using remote focusing, performed by moving an optical element near the laser and detector area of the mechanism. In that case, the laser beam, as it approaches the selected lenslet of the array, would have variable divergence/convergence, resulting in the ability to change the distance between the selected lenslet and the point where it focuses light.

The same, or a similar, approach is possible with the present invention, as discussed earlier herein. However, since this invention often uses a smaller lenslet array than that used in the prior art, focusing by moving either a selected lenslet, or the entire lenslet array, can usually be employed here. The difference between laser side (remote) and disk side (local) focusing will be explained below.

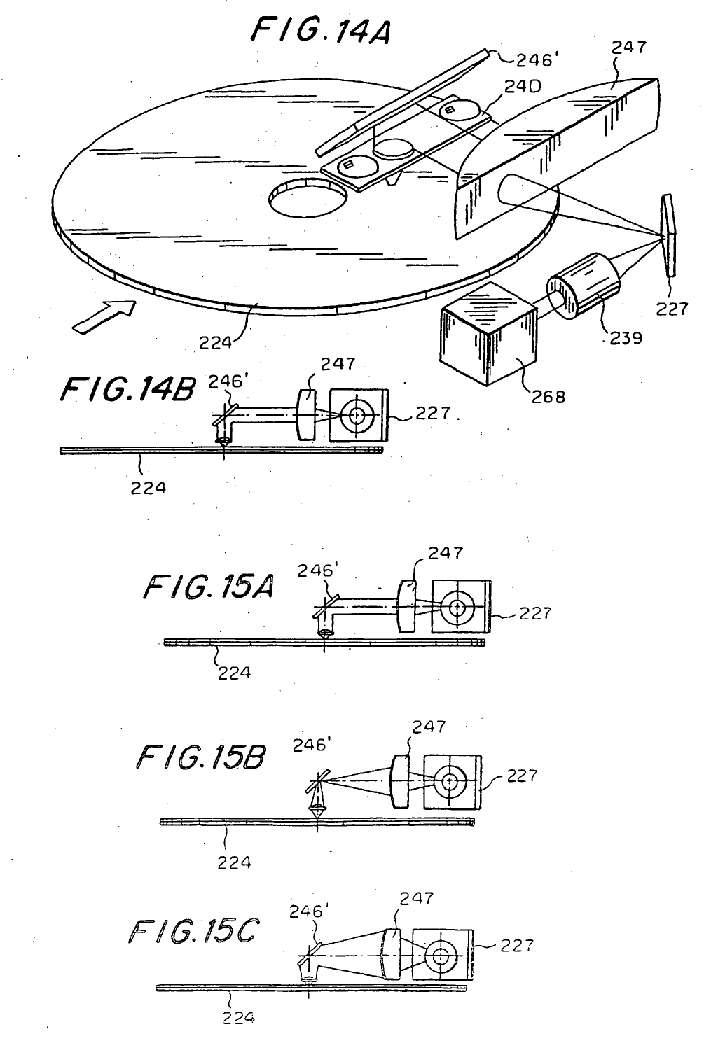

FIG. 14A is a simplified perspective view of an embodiment of the invention, with only the disk and key optical parts are depicted. For clarity, mechanical parts such as actuators and structural parts are omitted. The actual number of lenslets in the lenslet array can differ from the one shown. FIG. 14B is a side view of several of the components of FIG. 14A.

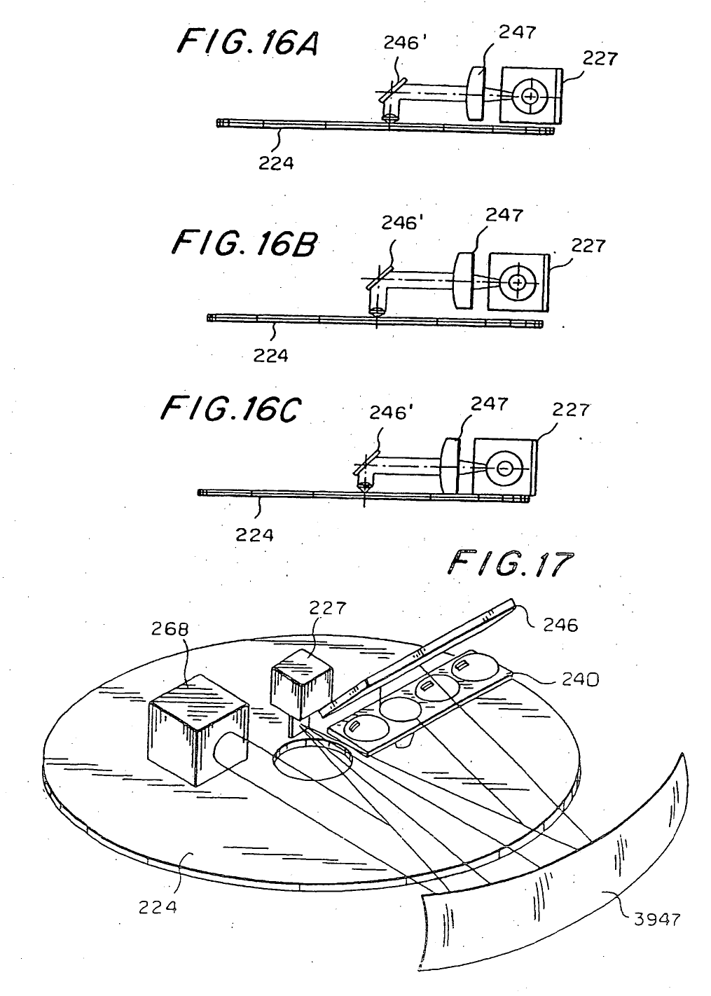

FIGS. 14A and 14B are used as a reference to help explain the illustrations provided in FIGS. 15A-15C and 16A-16C. Elements shown in FIGS. 14A and 14B that are given the same reference numerals as identical elements that were previously described.

In the operation of the arrangement shown in FIGS. 14A and 14B, light comes from a laser/detectors assembly 268 through a relay lens system 239 and is then reflected by a scanner mirror 227, passes through a collimating lens system 247, and is reflected by a mirror 246′ to reach the selected lenslet in lenslet array 240.

FIG. 14B is a small side view of the same system, as seen from the direction indicated by the large arrow of FIG. 14A.

FIGS. 15A-15C and 16A-16C are views of the system as viewed from that direction.

FIGS. 15A-15C and 16A-16C show the same system in three different focus positions. FIGS. 15A and 16A show the nominal focus position; the height of the disk data surface below the lenslet is about halfway between the two extreme positions. In this nominal position, light that enters the lenslet from lens system 247 is collimated.

FIGS. 15 depict laser-side focusing where the vertical position of the lenslet array does not vary and, therefore, the distance between the lenslet array and the disk changes. To facilitate focusing, the beam between the lenslet and the collimating lens system varies from collimated in FIG. 15A to diverging in FIG. 15B or converging in FIG. 15C. This variation in the convergence/divergence of the beam must result in variation in the beam diameter at lens system 247. In some cases it may become larger than the diameter of that beam on entering the lenslet.

FIGS. 16A-16C depict a system where focus following is done by simply moving the selected lenslet, or the entire lenslet array, down (FIG. 168) or up (FIG. 16C) to maintain constant the distance between the lenslet, or the lenslet array, and the disk data surface. Here, in all three positions, the beam between the lenslet and the collimating lens system remains essentially collimated, so that the beam diameter at lens system 247 is always nearly equal to the diameter at the lenslet.

The laser-side focusing approach facilitates smaller and lighter focusing actuator, but results in the need for a larger lens 247 and possibly more complex optical design. The disk-side focusing concept may be less elegant conceptually, but it allows smaller optics and enables more compact optical disk drives with, possibly, simpler optics.

It is possible to save on the number of optical components, and hence to lower manufacturing costs, by reusing the same piece of optics twice. FIG. 17 gives an example of an embodiment that does just this. It is best understood by comparing it with FIG. 14A. Here, a single reflective optical element 3947, such as a curved mirror, possibly having the form of an off-center paraboloid of rotation, performs the functions of both lens system 247 and lens system 239. Light from laser/detectors assembly 268 goes to this optical part, which sends it towards scanning mirror 227. Scanning mirror 227 returns the light to another location on optical element 3947, which reflects the light via mirror 246′ towards the selected lenslet of array 240, where the light is focused onto the disk data surface.

FIG. 17 must be viewed as just one representative example of many conceptually similar embodiments. For example, the curved mirror can be any combination of curved and/or flat optical surfaces, reflecting, refracting and/or diffractive, provided that they can satisfy the requirements set forth elsewhere herein and which are essentially the same as those discussed with reference to FIG. 8 of Ref. [2].

Also, the location of laser/detectors assembly 310 does not have to be as shown. The static folding mirror may be replaced by a static beam splitter and assembly 310 could be located behind the mirror, or it is possible to put laser/detectors assembly 310 just above the static mirror.

The foregoing description of the specific embodiments will so fully reveal the general nature of the invention that others can, by applying current knowledge, readily modify and/or adapt for various applications such specific embodiments without undue experimentation and without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. The means, materials, and steps for carrying out various disclosed functions may take a variety of alternative forms without departing from the invention.

Thus the expressions “means to . . . ” and “means for . . . ”, or any method step language, as may be found in the specification above and/or in the claims below, followed by a functional statement, are intended to define and cover whatever structural, physical, chemical or electrical element or structure, or whatever method step, which may now or in the future exist which carries out the recited function, whether or not precisely equivalent to the embodiment or embodiments disclosed in the specification above, i.e., other means or steps for carrying out the same functions can be used; and it is intended that such expressions be given their broadest interpretation.

### REFERENCES

[1] I. Glaser, “Two-dimensional random access scanner for optical disks,” U.S. Pat. No. Re. 36,393 (Nov. 16, 1999).
[2] I. Glaser and R. Glaser, “Methods and Apparatus for Optical Disk Drives using Optical Scanning” U.S. patent application Ser. No. 09/984,369 (Oct. 30, 2001).
[3] T. C. Damen, M. A. Daguay, Richard E. Haward, L. D. Jackel and W. J. Skocpol, “Optical disk read/write apparatus,” U.S. Pat. No. 4,550,249 (Oct. 29, 1985).
[4] U. J. Schmidt, “A high Speed Digital Light Deflector,” Phys. Lett. 12, 205-206 (1964). H. Meyer, D. Rickmann, K. P. Schmidt, U. J. Schmidt, M. Rahlff, E. Schroder and W. Thust, “Design and performance of a 20-stage digital light beam deflector,” Appl. Opt. 11, 1732 (1972).
[5]J. David Zook, “Light beam deflector performance: a comparative analysis,” Appl. Opt. 13, 875 (1974).
[6] Clive L. M. Ireland and John M. Ley, “Electro-optical deflectors” in Electro-Optic and Acousto-Optic Scanning and Deflection, M. Gottlieb, C. L. M. Ireland and J. M. Ley, editors, pp. 1-97, (Marcel-Dekker, New York (1983).
[7] J. Grinberg, T. R. O'Meara, Y. Owechko, N. Park, M. E. Pedinoff, T. Oaks, B. H. Soffer, “Phased array for optical beam control,” U.S. Pat. No. 4,937,539, assigned to Hughes Aircraft Co., Los Angeles, Calif. (Jun. 26, 1990).
[8] Qi Wang Song, Xu-Ming Wang, Rebecca Bussjager and Joseph Osman “Electro-optic beam-steering, device based on a lanthanum-modified lead zirconate titanate ceramic wafer,” Appl. Opt. 35, 3155 (1996).
[9] Shin Masuda, Sounosuke Takahashi, Toshiaki Nose, Susumu Sato and Hiromasa Ito, “Liquid-crystal microlens with a beam-steering function,” Appl. Opt. 36, 4772 (1997).
[10] Yoel Arieli, Salman Noach, Shmuel Ozeri, Naftali Eisenberg, “Design of Diffractive Optical Elements for Multiple Wavelengths, Appl. Opt. 37, 6174-6177 (1998).
[11] Guoliang Huang, Longfa Pan, Duanyi Xu, Jing Pei and Huibo Jia, “Holographic element for CD pickup-to-play PVD,” pp. 38-42 in Optical Recording, Storage, and Retrieval Systems, Proc. SPIE Vol. 2890, Feng Baogen and Tsunoda Yoshito Eds. (SPIE, Bellingham Wash., 1996).
[12] Mark O. Freeman, His Fu Shih, YuanChin Lee and JauJiu Ju, “LCD diffractive element design to handle multiple disk thicknesses,” p. 256-266 in Proc. SPIE Optical Storage and Optical Information Processing Vol. 4081, Han-Ping D. Shieh and Tom D. Milster; Eds. (SPIE, Bellingham Wash., 2000).
[13] Alan B. Marchant, Optical Recording: a Technical Overview (Addison Wesley, Reading Mass., 1990).

What is claimed is:

1. A system for optical scanning along one line with fast random access and high optical resolution, comprising:
a plurality of first lenslets constructed for use with a selected media format, said plurality of lenslets all being disposed in a single row and being spaced apart by a given center-to-center distance;
a movable mount carrying said plurality of lenslets;
a linear motion actuator coupled to said mount for moving said mount only in a direction substantially parallel to said single row over a distance having a maximum value that is substantially equal to or slightly greater than the given center-to-center distance;
at least one light source;
a light directing unit for directing light from said source to any one or two selected lenslets; and
a control unit for controlling said light directing unit.

2. The system of claim 1, wherein said single row of lenslets is arranged in at least approximately a straight line.

3. The system of claim 1, wherein each of said lenslets has a diameter not greater than about 20 mm.

4. The system of claim 1, wherein each of said lenslets comprises at least one of: a refractive surface; a reflective surface; a diffractive surface; a diffractive medium; and a gradient index optical material.

5. The system of claim 1, wherein said at least one light source comprises at least one laser.

6. The system of claim 5, wherein said at least one light source further comprises beam shaping optical elements.

7. The system of claim 6, wherein said light directing unit is a beam steering unit, a light deflector, or a scanner.

8. The system of claim 7, wherein said light directing unit comprises at least one of: a mechanical element; an electro-optical element; and an acousto-optical element.

9. The system of claim 1, wherein said system is operative to read and/or write data on rotating optical disk media containing data stored in the selected media format.

10. The system of claim 1, wherein said light directing unit comprises optical fibers coupling said light source to said lenslets.

11. The system of claim 1, wherein said light directing unit comprises an angular scanner that varies the angle at which light from said source is directed to said plurality of lenslets.

12. The system of claim 11, further comprising:
a first optical unit disposed between said light source and said light directing unit and containing at least one first optical element; and
a second optical unit disposed between said light directing unit and said plurality of lenslets and containing at least one second optical element.

13. The system of claim 12, wherein:
said plurality of lenslets have entrance pupils that are located in a common plane and said first and second optical units form a combined optical subsystem;
said combined optical subsystem has an entrance pupil that is in proximity to said light source and is imaged by said combined optical subsystem onto the plane of the entrance pupils of the plurality of lenslets in the lenslet array such that when light from said source is moved by said light directing unit, the entrance pupil of said combined optical subsystem can be located at, or very near, the entrance pupil of a selected lenslet;
said second optical unit has a focal plane that is at, or near, said light directing unit such that the direction at which light exits from said second optical unit towards the selected lenslet is substantially independent of which lenslet is selected and/or the state of said light directing unit.

14. The system of claim 12, further comprising a unit for supplying light that is focused to a spot to said first optical unit so that the focused spot of light is imaged by said first and second optical units at or near a surface of a media to be scanned and can be moved both above or below the media surface, and parallel to the optical axes of said lenslets without moving said lenslets or said light directing unit.

15. The system of claim 14, where said unit for supplying light that is focused to a spot comprises means for reading signals returned from the media surface and tracking and focus errors.

16. The system of claim 1, further comprising a second row of a plurality of second lenslets that are different from said first lenslets, carried by said movable mount, for use with a second media format different from said selected media format, and wherein said light direction unit comprises means for selectively directing light to one of said rows of lenslets.

17. The system of claim 16, wherein said at least one light source comprises a plurality of light sources each arranged to deliver light to a respective one of said rows of lenslets.

18. The system of claim 17, wherein each of said light sources produces light having a respectively different wavelength.

19. The system of claim 1, further comprising:
a row of elements for emitting or reflecting light carried by said movable mount; and
a position detector for detecting the position of said light emitters or reflectors to provide an electrical signal for controlling synchronization of movement of said movable mount and said light directing unit to cause light to be directed by said light directing unit at least approximately at the center of the entrance pupil of a selected lenslet.

20. The system of claim 19, wherein said row of elements are light reflecting elements and said system further comprises a second light source for illuminating said light reflecting elements.

21. The system of claim 20, further comprising a beam splitting optical element cooperating with said second light source.

22. The system of claim 1 for scanning a surface of a disc constituting a media containing data arranged in a plurality of tracks, wherein:
said at least one light source produces at least two laser beams for simultaneously illuminating at least two spots on the disc surface, each spot being illuminated by a respective beam; and
said system further comprises a plurality of signal detectors for facilitating readout of light reflected from each spot separately at the same time, thereby allowing simultaneous readout of several tracks of the media at the same time.

23. The system of claim 22, wherein said at least one light source comprises 2 plurality of lasers, or a single laser and an optical element to create multiple beams.

24. The system of claim 22, wherein said at least one light source comprises a single laser and an optical element to create multiple beams and said optical element comprises at least one of a diffraction grating and a polarization based prism.

25. A method for positioning a light spot on a surface of a moving optical disc containing optically readable data arrange in a plurality of tracks during a random access operation, said method comprising:
analyzing previous tracking error signals;
predicting, on the basis of said analysis, track movements due to disk eccentricity and mechanical imprecision; and
based on the result of said predicting step, positioning the light spot during the random access operation very close a target track, thereby minimizing the time needed to access the target track.
